(19) United States
(12) Patent Application Publication
(10) Pub. No.: US 2002/0164441 A1
(43) Pub. Date: Nov. 7, 2002

(54) Packaging for primary and secondary batteries

(75) Inventors: Khalil Amine, Downers Grove, IL (US); Aron Newman, Chicago, IL (US); Donald Vissers, Naperville, IL (US); Andrew Jansen, Bolingbrook, IL (US)

Correspondence Address: FOLEY & LARDNER, 150 EAST GILMAN STREET, P.O. BOX 1497, MADISON, WI, 53701-1497, US

(73) Assignee: The University of Chicago

(21) Appl. No.: 10/084,573

(22) Filed: Feb. 27, 2002

Related U.S. Application Data
(60) Provisional application No. 60/272,396, filed on Mar. 1, 2001.

(51) Int. Cl. B32B 1/02

(52) U.S. Cl. 428/35.2

(57) ABSTRACT

A housing for a battery comprising a laminate made of a plurality of layers is provided. The battery housing has at least a barrier layer, typically two metal foils, and a sealing layer, which is intended to be in contact with the contents of a battery. Additionally, the battery housing can further include a protective layer over the barrier layer. Suitable materials for the sealant layer and barrier layers include polymers. Preferably, the laminate battery housing is flexible, although this is not required. The sealant layer, barrier layer and protective layer may also be adhesively attached. The battery housing of the present invention can also provide moisture and acid absorbers in various configurations.

### CROSS-REFERENCES TO RELATED APPLICATIONS

This application claims priority to U.S. Provisional Application No. 60/272,396, filed Mar. 1, 2001, the entire disclosure of which is incorporated herein by reference.

### STATEMENT OF GOVERNMENT INTERESTS

This invention was made with Government support under Contract No. W-31-109-ENG-38 between the U.S. Department of Energy (DOE) and The University of Chicago representing Argonne National Laboratory. The Government has certain rights in this invention.

### FIELD OF THE INVENTION

The present invention relates to packaging for the containment of primary and secondary batteries and for the fabrication of such packaging. More particularly, the invention relates to a packaging for the containment of primary and secondary batteries that is flexible and comprises laminates having a plurality of polymer and metal foil layers. In various embodiments, adsorbents are incorporated into the laminates and at the packaging perimeter between multiple heat seals.

### BACKGROUND OF THE INVENTION

In order to provide motive force and for other electrical purposes, electric and hybrid electric vehicles require an onboard source of electricity which is capable of supplying a large amount of electrical power. Typically, the electrical power is provided by a plurality of batteries, usually lithium ion batteries, housed together in a large battery pack. These battery packs can include a stack of 100 individual cells or more. Battery packs found in electric vehicles (EVs) make a significant contribution to the weight of these vehicles, approaching 50 percent of the total vehicle weight. Additionally, the battery packs in both electric and hybrid electric vehicles maybe one of the more expensive components of these vehicles. Due to the size of the battery packs in these EVs and their rigid conformation, the location of the battery packs is limited to specific areas of the vehicle. The location of these battery packs cannot only hinder the handling and performance of these EVs, it can also make it difficult and expensive to replace individual cells which have become non-functioning.

The materials and processing that go into the production of batteries for hybrid and electric vehicles are extremely costly. Today, most batteries are packaged in deep drawn cans made from either stainless steel or aluminum. These cans are rigid, expensive, and have to go through an expensive sealing process, such as laser welding in order to be appropriate for use as a battery housing. Furthermore, in order to address safety concerns, current batteries packaged in deep drawn cans require a special safety vent which has to be specifically adapted to the battery housing. Additionally, current battery housings must also incorporate expensive elements to accommodate terminal feedthroughs. Not only are the materials used for current battery housings expensive, batteries based on these housings are expensive to manufacture and the batteries that incorporate these housings are quite heavy.

Similar problems and difficulties are also present in batteries used across a wide range of technologies and accordingly are not limited to batteries utilized in electric and hybrid electric vehicles.

As an alternative to the can-type housing, a battery may be packaged in a flexible housing. Flexible housings may be made of metal foils, layers of plastic or a combination of the two. The flexible housings currently available include those made from a heat-sealable plastic layer in contact with a metal foil. In these housing constructions the plastic layer generally acts as a sealant and a barrier to the escape of chemical components commonly found in electrolytes, while the metal foil prevents moisture and air from entering the battery and acts as a barrier to the chemical components of the electrolyte diffusing through the face of the sealant layer. Unfortunately, these housings have met with limited success because metal foils do not entirely prevent the transmission of water through the housing and because decomposition products from electrolytes, such as hydrofluoric acid (HF), are able to escape through seals, which can result in the breaching of battery housings. HF can form when many common electrolytes are exposed to moisture.

Thus a need exists for an inexpensive, flexible battery housing that provides an improved barrier to water, air and chemicals commonly found in electrolytes.

### SUMMARY OF THE INVENTION

This invention relates to a new approach in developing a flexible packaging with long calendar life for use in all kinds of batteries and more specifically for use in the lithium ion batteries used in electric and hybrid electric vehicles. More specifically, the invention relates to packaging made from laminates that may or may not be used as a replacement for rigid metal can type housings.

One aspect of the present invention provides a laminate for use as a battery housing. The laminate is made up of a sealant layer that is capable of acting as a barrier to an electrolyte. The sealant layer further has at least two surfaces, one surface being an internal surface that is substantially inert to battery electrolytes and an external surface. The laminate has another layer, a barrier layer, which has a surface disposed adjacent to the external surface of the sealant layer, and an external surface. Typically, the sealant layer will be a polymer and the barrier layer will comprise two layers of metal foil, such as aluminum foil.

Another aspect of the present invention provides a laminate having substantially the same components as described above that further comprises a protective layer. The protective layer has a surface disposed adjacent to the external surface of the moisture barrier layer. In various embodiments the protective layer is a polymer.

In the above-described embodiments, either the sealant layer or the protective layer can contain an absorbent that absorbs water and/or byproducts of battery reactions, such as acids. Additionally, the layers of the laminates can be attached together with a suitable adhesive which itself contains an absorbent.

Yet another aspect of the present invention provides a laminate comprising a sealant layer having an absorbent material pattern printed on its internal surface. The absorbent material absorbs water and/or byproducts of battery reactions, such as acids.

Still another aspect of the present invention provides a battery comprising a battery cell or cells housed in a pouch made from one of the laminate configurations described above. When formed into a pouch, the laminate housing provides an interior cavity and an external surface. In a battery construction, the interior cavity of the pouch is substantially filled with an electrolyte, and will be substantially defined by a part of the internal surface of the flexible sealant layer of the laminate. In order to provide electrical power, the battery also has a separator and two electrodes, wherein the terminals extend from the interior cavity of the pouch containing the electrolyte to the exterior of the pouch.

In one embodiment, the present invention provides a battery housing comprising a laminate made from a sealant layer that has been fashioned into a pouch that is closed by at least one double seal. The double seal consists of two sealing regions that define a hollow channel between them. In this embodiment, an absorbent material is contained within the channel. The absorbent material absorbs water and/or byproducts of battery reactions, such as acids.

The above described objectives and embodiments are set forth in the following description and illustrated in the drawings described below.

### BRIEF DESCRIPTION OF THE DRAWINGS

The preferred exemplary embodiment of the invention will hereinafter be described in conjunction with the appended drawings, wherein like numerals denote like elements and:

FIG. 1 is a schematic diagram of a flexible laminate produced according to the present invention;

FIG. 2 is a perspective view of one of the feedthroughs of a battery made according to the present invention;

FIG. 3 is a perspective view of a battery assembly according to the present invention depicting two electrical terminals and the sealing regions of a pouch made from the flexible laminate of the present invention;

FIG. 4 is a perspective view of a battery assembly showing two electrical terminals and the double sealing regions of a pouch made from the flexible laminate of the present invention; and

FIG. 5 is a partial cut-away of the elevationed view of one of the double sealing regions of FIG. 4 taken along line 5-5 and showing the optionally encapsulated absorbent.

FIG. 6 is graph of solvent loss rates through pouches made from laminates with either a single thicker foil or two thinner foils, versus temperature.

FIG. 7 is a graph of solvent vapor and water vapor uptake of various molecular sieve absorbents.

### DETAILED DESCRIPTION OF THE PREFERRED EMBODIMENTS

As used herein, the term “battery” may include a single cell, or a number of cells connected in either series or parallel to furnish electrical current.

The term “cell” includes a positive active material layer, a negative active material layer and an electrolyte-filled separator layer, a pair of conductive terminals, or a number of these layers connected in bi-faced, bi-polar, or other cell configuration designs known to those skilled in the art.

In one embodiment of the invention, the battery housing or package is a flexible laminate comprising a pair of metal foils that act as a moisture and/or electrolyte component barrier and an inner sealant layer that acts as a barrier to the escape of electrolyte materials and their decomposition products, such as hydrogen fluoride. Suitable metal foils include, but are not limited to, foils made of aluminum, stainless steel, nickel, copper, and alloys thereof. This embodiment may optionally include an outer protective layer.

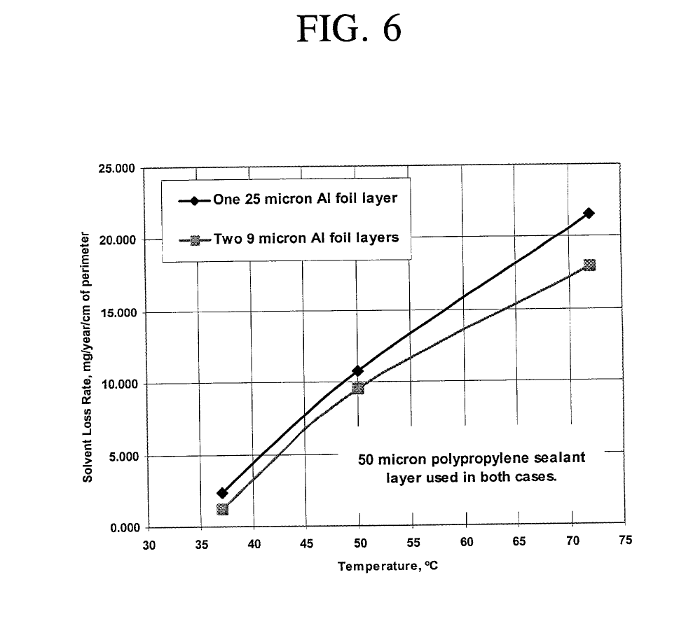

This embodiment of the invention takes advantage of the inventors' surprising discovery that a barrier made of two layers of thin metal foil has improved solvent impermeability compared to a barrier made from a single thicker metal foil. The inventors believe this result can be explained by the fact that two layers of thin metal foil provide significant advantages over a single thicker layer of foil while eliminating some of the disadvantages. One advantage is the improved permeation characteristics of the double foil. Evidence of this is provided in FIG. 6, which is described in more detail below. This results from the fact that the pinholes in the respective thin layers do not align with one another when the metal foils are overlaid, thus significantly improving the permeation characteristics of the two layers of foil. Specifically, double metal laminates can provide a pinhole count of approximately one per square foot or less. At the same time, however, the foils remain thin enough to prevent foil cracking during handling. Foil cracking is a common problem with thicker foils and leads to a substantial reduction in a foil's ability to act as a barrier. Also, it becomes difficult to heat seal a laminate if the metal foil barrier is too thick (usually >50 microns). This is due to the much higher thermal conductivity of the metal in comparison to plastics. Hence, laminates with two thinner foils will have several advantages over a laminate with one thick foil, provided that the combined thickness of the multiple thinner foils is less than the thickness of the one thicker foil.

Inherent in this design, the sealant layer has at least two surfaces, one surface being an internal surface that is substantially inert to electrolytes and an external surface. Also, the flexible barrier layer has a surface disposed adjacent to the external surface of the flexible sealant layer and an external surface. If the laminate includes a flexible protective layer, that layer is disposed adjacent to the external surface of the flexible barrier layer.

In this embodiment, the sealant layer, the protective layer, or both may be made from polymers. Suitable polymers include, but are not limited to polyesters, polyamides, polyvinylchlorides, fluoroplastics, and polyolefins. Examples of suitable polymers include, low density polyethylene, high density polyethylene, medium density polyethylene, linear low density polyethylene (LLDPE), copolymers of ethylene and alpha-olefins, two-ply high density polyethylene/linear low density polyethylene, ethylene interpolymers (ionomers) (e.g., surlyn), polyethylene terephthalate, polypropylene, polychloro-trifluoroethylene, polyphenylene sulfide, ethylene vinyl acetate, ethylene vinyl alcohol, nitrile resin films, nylon, and combinations thereof. Rubber may also be suitable for the protective and sealing layers. In other embodiments of the battery housing, the flexible sealant layer and the protective layer may be made of different polymers or layers of polymers to meet the requirements for the battery housing require.

Flexible packaging comprising a heat-sealable seal layer has some drawbacks over conventional battery housings. For example, a polymer that is able to be heat sealed at a reasonable temperature may not be well suited as a barrier to electrolytes. High crystallinity of the polymer leads to better barriers but poor heat sealability. Thus, solvents from the electrolyte of lithium ion cells can migrate through many heat sealable polymers and attack any adhesive or interface between the foil and the sealant layer. Degradation of the adhesive or interface can then lead to delamination of the battery housing and ultimately a breaching of the sealed pouch. Accordingly, it may be desirable to balance the need for containing the chosen electrolyte against the sealability of the polymer in order to choose the most suitable polymer for the sealant layer. Alternatively, this problem may be solved by providing two or more layers of polymer for the sealant layer of the laminate. One layer of polymer can have increased resistance to the permeability and chemical reactivity of the electrolyte, while the other layer or layers can provide increased heat sealability.

The above layers can be joined by a variety of ways well understood to those skilled in the art, and may include, but are not limited to, heat based lamination and extrusion. Heat based lamination can involve the use of thermoplastic hot-melt adhesives, for example ethylene acrylic acid (EAA) or adhesives using elevated temperature curing. Preferred adhesive types include polyurethanes, epoxy resins, polysulfide systems, reactive acrylate adhesives, UV curable adhesives for polymer/foil bond, cyanoacryolates, and silicone adhesives. Suitable polymers (e.g. polyethylene, polypropylene) can be extruded directly from the melt onto the metal foil(s) to form the sealant layer and and/or the protective layer.

The sealing layer should have a sealing strength that is capable of withstanding pressures similar to or higher than pressures that release gas through the safety vent in conventional batteries. As a result a battery housing made from the new flexible packaging laminate can operate without a safety vent. When the laminate of the present invention is formed into a pouch for a battery, the lower open end of the pouch is preferably sealed twice. Electrode feedthroughs with heat sealable supports are sealed into the remaining open end to complete the sealing operation. The strength of this seal serves as a pressure release should the interior pressure of the battery reach too high a limit. Thus, the need for an expensive safety vent is obviated by the construction and materials of the present battery. Battery housings having laminate construction as described herein have been found to have burst pressures substantially in excess of 70 psi. Furthermore, the sealing layer, which will be in direct contact with the cell components including an electrolyte when the laminate is fashioned into a battery housing, should be substantially inert to electrolyte reactivity and should not react substantially with electrolyte at any given cell temperature. Preferably, the sealant layer can act accordingly at temperatures between about −40° C. to about 80° C. and more preferably at a temperature range of between about 25° C. to 60° C., which is the temperature range where most batteries need to operate.

In one embodiment of the packaging laminate, the two layers of a metal foil are made of aluminum, the protective layer is made of a polymer such as a polyester and a sealant layer is made of a second polymer such as a polyethylene.

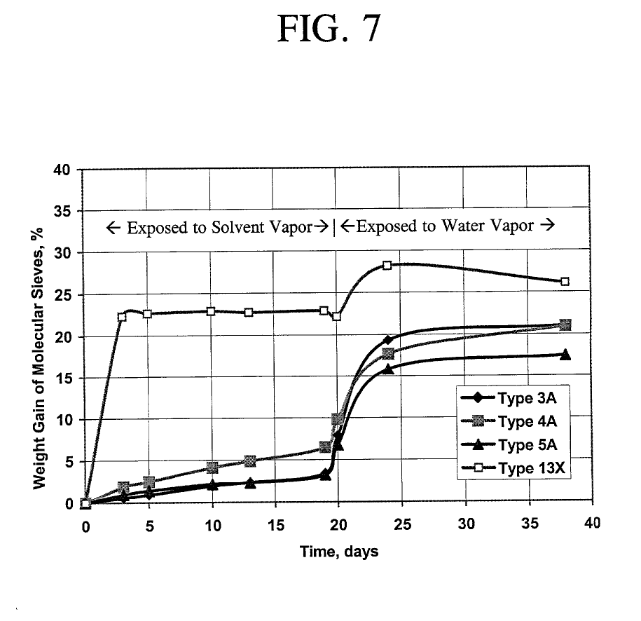

One or more adhesives can be used between any or all of the layers in the laminate, including the two layers of metal foil. Examples of suitable adhesives include polyurethanes, epoxy adhesives, and ethylene acrylic acid copolymers. Additionally, an absorbent material can be mixed into any of the polymer layers or into the adhesive. Methods of providing absorbent-containing polymer layers or adhesive are known in the art and include, but are not limited to blending absorbent particles into an adhesive or a softened polymer or entraining or dispersing an absorbent material into a polymer formulation during processing. Suitable absorbents include, but are not limited to, dehydrated magnesium phosphate, dehydrated manganese sulfate, activated alumina, silica gel, calcium sulfate (drierite), molecular sieves, clays, water-absorbent resins, other salts capable of forming hydrates including phosphates, borates, and sulfates, and combinations thereof. Preferential absorbents should absorb moisture and/or acid byproducts from decomposition of the electrolyte without absorbing the initial components of the electrolyte. Absorbents were tested by exposing the dried absorbent to electrolye solvent vapor and then to water vapor while monitoring their weight change. As an example, molecular sieves Type 3A, Type 4A, and Type 5A were found to preferentially absorb moisture over solvent as can be seen in FIG. 7. These sieves also have the desired property of readily reacting with HF acid. Further tests were performed to see if the absorbent material adversely reacted with the electrolyte salt. An example of a test is shown in Table 1, which is a summary of the amount of lithium ions from the electrolyte that are exchanged with sodium, potassium, and calcium ions present in several molecular sieves. From all of these tests shown here, an example of a particularly suitable absorbent would be Molecular Sieve Type 5A.

TABLE 1
Milligrams of cation exchanged by lithium per gram of molecular sieve.

| Molecular Sieve | Sodium | Potassium | Calcium |
|---|---|---|---|
| Type 3A | 20.1 | 27.8 | <0.03 |
| Type 4A | 57.4 | <0.5 | <0.03 |
| Type 5A | 4.1 | <0.5 | <0.03 |

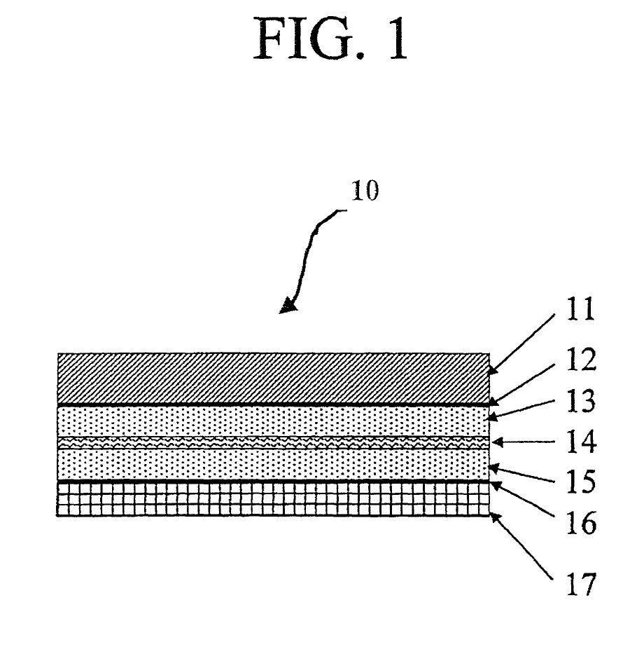

FIG. 1 shows a preferred example of a battery housing laminate 10 made according to the present invention. The laminate 10 comprises a laminated flexible packaging having a number of layers that play a protective role for the contents of the battery. The plurality of layers also provide support and protection for the other layers of the laminate housing and further enhance the sealing of the inner pouch. The flexible packaging is composed of a protective layer 11 joined by an adhesive 12 to a first metal foil 13, such as aluminum. The first foil layer 13 is in turn attached with adhesive 14 to a second metal foil layer 15. The second metal foil layer 15 is further attached with an adhesive 16 to a sealing layer 17, which is preferably a thermoplastic polymer. Adhesives 12, 14 and 16 can be the same or similar adhesive or can be adhesives of vastly differing characteristics as desired. Adhesives 12 and/or 16 can be eliminated if the protective polymer layer and sealant layer are extruded directly from a melt onto the foils.

To prevent any potential degradation of an electrolyte packaged in a housing made from the laminates of this invention, especially non aqueous electrolytes or air sensitive active materials, by moisture permeating through the layers from outside of the housing, the sealant layer 17, the protective layer 11, or any of the adhesive layers 12, 14, or 16 can be blended with moisture absorbent. In the case where an electrolyte, such as lithium hexafluorophoshate salt in a mixture of one or more of the following solvents: ethylene carbonate, diethyl carbonate, ethyl methyl carbonate, dimethyl carbonate, and propylene carbonate, generates corrosive acid, such as hydrofluoric acid (HF), the absorbent should also be chosen to absorb and/or neutralize acid. In this manner, any acid released by the electrolyte will be trapped in the absorbent, preferably contained in sealant layer 17, thus preventing the degradation of the integrity of the laminate structure, and in particular the metal foil layers 13 and 15. Examples of suitable polymeric materials for incorporation into sealant layer 17 or protective layer 11 are mentioned above.

Protective layer 11 acts as a first barrier to environmental moisture. Protective layer 11 further serves to protect the metal foil layers, in particular layer 13, from being penetrated or damaged, for example by scratching or puncture, especially during handling of the battery. The first foil layer 13 provides a second barrier against any potential moisture permeation. The foil can vary in thickness from about 6 μm to about 120 μm. In certain embodiments the foil thickness is in the range of about 5 μm to 50 μm, in other embodiments the foil thickness is about 9 μm to 18 μm. The thickness of the foil should be chosen in a way such that the number of pinholes per square inch is extremely low, however the foil should not be so thick as to allow for easier cracking of the foil or so thick that the laminate cannot easily be heat sealed. One skilled in the art will also recognize that the thickness of the foil will vary depending on the metal foil used, and the quality of the metal foil incorporated into the flexible laminate housing. The second foil layer 15 will also act as an acid barrier to any acid originating from an electrolyte that permeates the sealant layer 17. Preferred examples of aluminum foil alloys for incorporation into metal foil layers 13 and 15 are Aluminum Association designation types 1100, 1145, and 8112 aluminum alloys, which are commonly used in the packaging industry due to their corrosion resistance, flexibility, and strength.

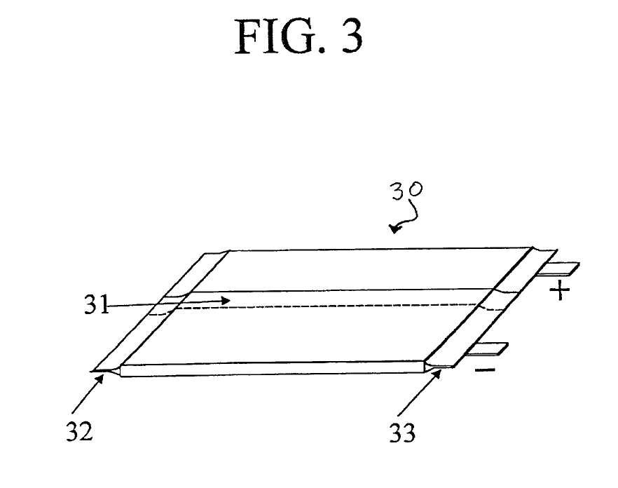

The adhesive layer 14 joins foil layers 13 and 15. Adhesive layer 14 can also be blended with moisture and acid absorbents to prevent moisture permeation toward the inner part of the cell and HF or corrosive acid permeation toward the outer part of the cell as shown in FIG. 3. In this case, blending the sealing layer 17 with moisture and acid absorbents can extend significantly the calendar life of the battery and flexible packaging.

Although the preferred embodiment of FIG. 1 above depicts the layers of the flexible laminate housing according to the present invention as attached with adhesive, these layers need not be joined together except where a sealing region of the housing is present, and the sealing regions need not be sealed with adhesive. Thus, the layers of the flexible laminate housing may “float” or slide over one another in a non-adhered fashion. If the layers are not attached to one another, except obviously at the seams, the layers may be provided with folds or extra amounts of laminate material so that the flexibility of the battery housing is further increased.

In an alternative embodiment, the present invention contemplates a flexible laminate comprising a sealant layer that has absorbent particles coated on one surface. The application of the absorbent particles to the sealant layer is accomplished through pattern coating. The procedure used in this process is known to those experienced in the art of printing. Briefly, the absorbent particles, nominally 5-10 micrometers in diameter, are mixed into a slurry of solvent (e.g., NMP, THF) and binder (e.g., polyvinylidene fluoride) to produce a viscosity of less than 1 centipoise. This mixture will serve as the “ink” for the pattern printing of dots onto one surface of the sealant layer. This is commonly referred to as flexographic and also rotogravure printing. A more detailed description of this procedure can be found in Volume 14 of the Encyclopedia of Chemical Technology, 4^{th} Ed. by Kirk-Othmer, which is herein incorporated by reference. The absorbent particles must be small, typically 1 to 5 microns, to achieve the best slurry and viscosity. Pattern printing the absorbent on the internal surface of the sealant layer is preferable to other methods of coating the absorbent onto the sealant layer because it does an excellent job of forming a uniform and thin layer of adsorbent in a well defined area unlike other coating techniques, and is quite inexpensive.

This embodiment may optionally include a moisture barrier layer adjacent to the sealant layer and/or an outer protective layer. Both of these layers have already been described above in detail. In various embodiments, the sealant layer, the moisture barrier layer, and the protective layer are made from polymers. Suitable polymers for use as the sealant and protective layers are described above. Suitable polymers for use as the moisture barrier layer include, but are not limited to, polyesters, polypropylene, polyethylene, polypropylene/polyethylene blends, and polyvinylidiene chloride. In alternative embodiments, the sealant layer and the protective layer are made from polymers and the moisture barrier layer is made from a metal foil.

The above layers can be joined in a variety of ways, as previously described.

In order to provide additional protection against electrolyte degradation, the sealant layer, the moisture barrier layer, the protective layer, and any adhesive layers can be blended with a moisture and/or acid absorbent as previously described.

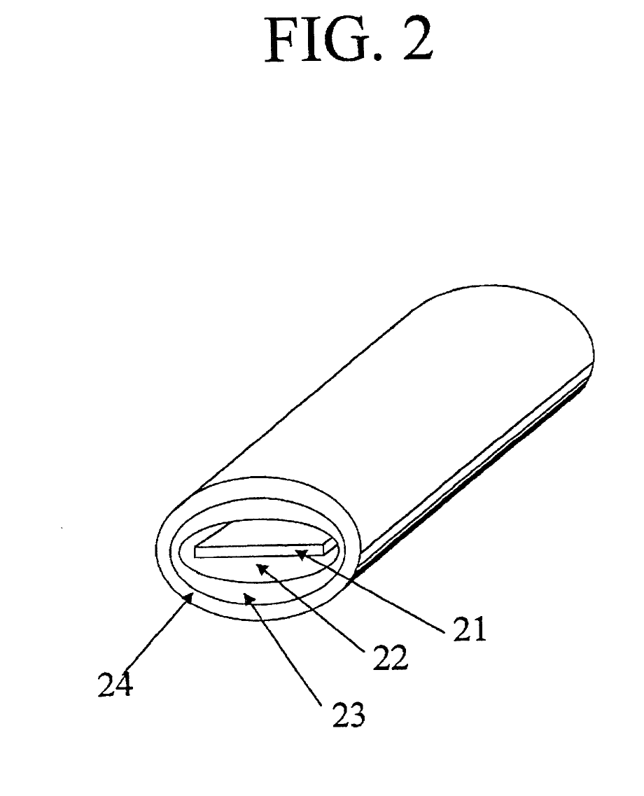

FIG. 2 shows the design of the feedthrough assembly composed in a coaxial configuration according to a preferred embodiment of the present invention. From the center outward the materials are a conductor 21, adhesive 22, blend of adhesive and absorbent 23, and sealant 24. The conductor 21 is typically aluminum for the cathode and nickel or copper for the anode, although a person having ordinary skill in the art will understand that other materials and metals may be substituted for the conductor 21. Examples of adhesives which are suitable for the present invention include, but are not limited to, polyurethanes, epoxy adhesives, or ethylene acrylic acid copolymers. Preferably, the absorbent selectively absorbs water as opposed to organic solvents as this can lead to electrolyte starvation in the cell. It has been found that silica gel is not preferred in all embodiments because silica gel can absorb excess amounts of organic solvents.

An example of a battery housed in flexible packaging according to the present invention is shown in FIG. 3. FIG. 3 depicts a battery assembly 30 showing two electrical terminals (+) and (−), a longitudinal sealing region 31, and two transverse sealing regions 32 and 33. Sealing regions 31, 32, and 33 may be sealed through conventional heat sealing, or alternatively the sealing regions can be sealed with suitable adhesives. From the depiction of the preferred battery of FIG. 3, a method of making a battery according to the present invention also becomes apparent. Typically, making a pouch for the battery of FIG. 3 will involve cutting a rectangular piece of laminate housing of the present invention, forming longitudinal seal 31 and then forming transverse seal 32. After the seals are formed as described above, the housing will then be in a pouch configuration suitable for accepting the one or more battery cells. After the cell is included in the battery pouch, transverse sealing region 33 is formed to seal the contents in the interior of the battery, with the cell electrode terminals extending beyond the pouch to the exterior of the battery. Although transverse seals 32 and 33 could be formed first, it will be obvious to one of ordinary skill in the art why it is preferable to form longitudinal seal 31 first. Alternatively, a pouch cell could be made by folding a long laminate sheet in half, making two longitudinal seals along the sides, inserting the cell with electrode leads, and then making one transverse seal at the electrode side of the pouch.

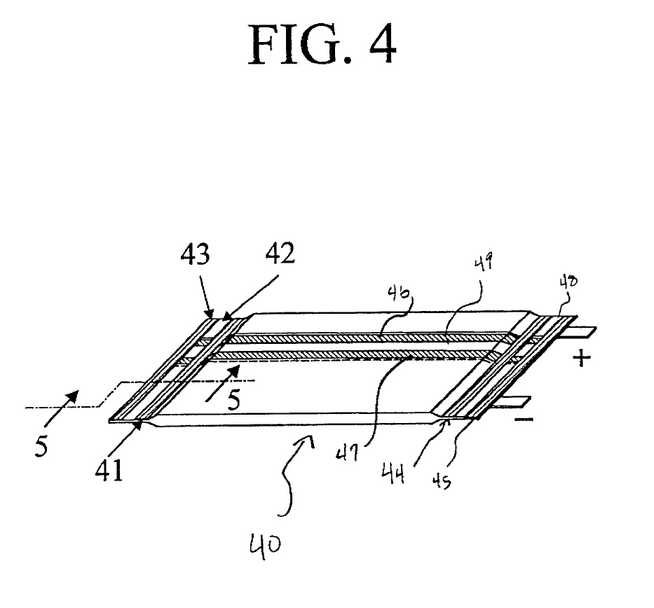

In one variation of the battery housings of the present invention, at least one seam of the housing is sealed with a double seal. The double seal is characterized by making two seals. The first seal defines the interior region of the pouch, while the second sealing region defines the outer region of the pouch and creates a hollow channel, or cavity, between them. The double seals could be made at the same time with a heating jaw that has an empty grove that runs down the face of it or by two heating jaws placed together with an empty space between them. Alternatively, the inner seam could be made first with a single jaw heater, an absorbent material applied as a ribbon, caulk, powder, etc., then the second seal is made along side the absorbent material with a single jaw heater. In some embodiments, the absorbent may have been applied to the laminate before assembly of the cell or bag, for instance, as an ink or hot melt pattern coating. Regardless of the sequence of events or apparatus, the result is the formation of a channel that contains an absorbent material that serves to prevent moisture from leaking into the housing through the seal and/or to prevent acid and other degradation products from leaking out of the housing through the seal. This is particularly advantageous because the sealing regions in a battery housing tend to be particularly susceptible to permeation by either moisture or acids. In various embodiments the two sealing regions are oriented approximately parallel. FIG. 4 shows an example of a housing having three double seals. FIG. 4 depicts a battery assembly 40 showing the two electrical terminals (+) and (−), and four transverse sealing regions 41, 43, 44 and 45, and two longitudinal sealing regions 46 and 47. Transverse sealing regions 41 and 43 provide a double seal arrangement leaving a channel 42 in the housing of the battery. Similarly, transverse regions 44 and 45 and longitudinal regions 46 and 47 provide double seals and result in channels 48 and 49 respectively. Regions 42, 48 and 49 depict channels between the seals that can be useful to extend the life of the battery of the present invention. Channels 42, 48 and 49 can contain absorbents for moisture and/or acid and are thus suitable to prevent the degradation of the electrolyte, flexible laminate housing, and/or sealing regions of the present battery. Accordingly, the shelf-life and useful life of the battery can be extended greatly with only a little added cost. Suitable absorbents are listed above. The battery of FIG. 4 is manufactured in a fashion similar to that discussed with regard to the battery of FIG. 3.

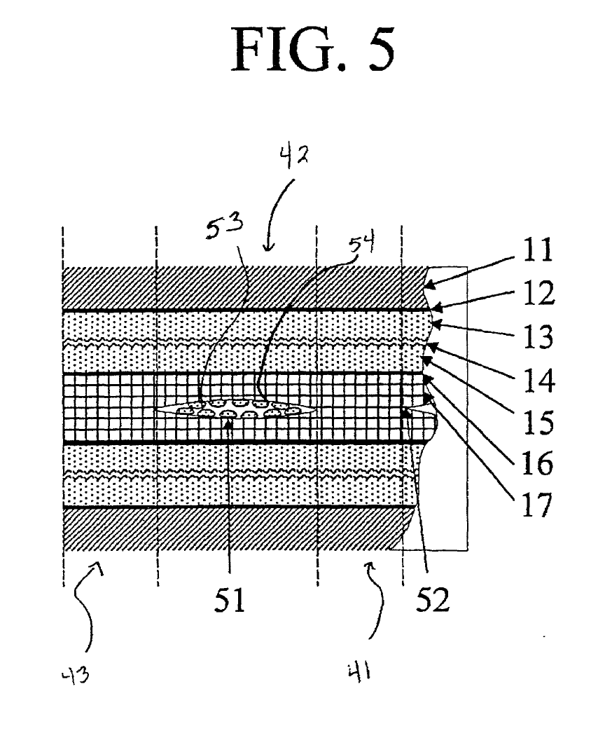

FIG. 5 shows a detail of the channel region of FIG. 4 containing an absorbent. As can be seen from the magnified view of one of the transverse sealing regions of FIG. 4, transverse sealing regions 41 and 43 provide a non-sealed region 42. Because region 42 is non-sealed, a channel, or cavity 51 exists which is capable of containing absorbent material 53. Absorbent material 53 contained in cavity 51 can be loose in the cavity, but it is preferably pattern printed to the internal surface 54 of the sealant layer 17. The edge 52 of the pouch cavity of the battery is defined by inner side of transverse seal 41. The interior of the battery 40 can also contain a pouch of suitable moisture and/or acid absorbent to increase the lifetime of the battery. As a result of these absorbent-containing cavities, such as cavity 51, the battery packaging provided by the present invention is expected to have a calendar life exceeding 15 years.

Although the longitudinal sealing regions of the batteries of FIGS. 3 and 4 are depicted on the upper flat surface of the batteries, it will be apparent to one skilled in the art that these sealing regions may be placed anywhere about the battery. These longitudinal sealing regions can be advantageously placed on the vertical sections of the battery so that more than one separate cell can be pleated and joined in the same single battery housing. That is, separate cells can share a common sealing region and thus be housed together in a common housing. This can provide the many benefits described before. Additionally, electrode leads can be placed between these separate cells sharing a single housing to wire the cells in any manner well known in the art, for example in sequence or parallel, without additional electronic components. This shared sealing region arrangement can also take place on any of the transverse sealing regions of the present batteries.

According to the embodiments shown in FIGS. 3 or 4, the perimeter of the battery (2×length+2×width) is in the range of about 10 cm to 120 cm. While the battery shown here is produced in a rectangular shape, it will be obvious that a battery incorporating the present flexible housing can be produced in any shape desired, for example, round, cylindrical, star-shaped, orthogonal, donut-shaped, etc. Additionally, although certain embodiments of the present invention provide batteries or housings for batteries that are flexible, this is not required to carry out the present invention. Accordingly, laminated structures for use as battery housings disclosed by the present invention can themselves be rigid or can be incorporated into rigid structures.

The application of the flexible packaging of the present invention is not particularly limited. This laminate assembly can be utilized for primary or secondary batteries of aqueous or nonaqueous chemistries. In the case of an aqueous-based battery, the moisture absorbent would be eliminated or replaced by a non-moisture absorbent material. The chemical barriers in this invention will minimize transport of most gases and liquids. Examples of aqueous primary batteries include, but are not limited to, alkaline, zinc-carbon, mercuric oxide, silver oxide, and zinc-air. Examples of aqueous secondary batteries include, but are not limited to, nickel cadmium, lead acid, nickel-iron, and nickel metal hydride. Examples of non-aqueous primary batteries include, but are not limited to, lithium/iron sulfide, lithium/vanadium oxide, and lithium/manganese dioxide. Examples of non-aqueous secondary batteries include, but are not limited to, lithium ion, lithium polymer, and lithium-ion polymer.

The proposed flexible packaging will reduce significantly the cost of the battery, by eliminating the welding of the battery can and inspection thereof, expensive feedthroughs, and safety vents. These laminates are chosen to play a role against any leakage, electrolyte decomposition, moisture effect where appropriate and potential HF corrosion depending on the chemistry of the battery chosen. These features will further extend the lifetime of the respective cells and batteries.

Although the preferred embodiment of the invention is intended to be used for a lithium ion battery associated with a hybrid electric vehicle, a person having ordinary skill in the art will recognize that application of the present invention extends to all self-contained electricity producing systems and in particular all types of batteries. For example, the present invention can be used for battery housings for batteries used in conventional consumer electronics. Another advantage of batteries produced according to the present invention is that the batteries are no longer shape limited. That is, a battery with a wide range of voltages can be produced in a wide range of sizes and shapes. Additionally, although a battery of a desired voltage made according to the present invention may be of a particular shape, due to the flexible nature of the battery housing, the battery of the present invention is capable of fitting into holding areas not designed for the specific shape of the battery currently being used.

Additionally, because of the nature of the battery housing disclosed herein it is possible to manufacture a battery housing according to the present invention which is capable of housing more than one separate cell within the same battery housing. This may be particularly desirable, for instance, when more than one cell is replaced at the same time, as is often the case in consumer electronics. It is also often desirable to replace multiple cells at once in electric and hybrid electric vehicles. When cells according to the present invention are housed together in this manner one does not have to worry about having old and new cells mixed together, possibly having different useful lifetimes, in the same electronic device. A person of ordinary skill in the art will also recognize that when multiple cells are housed in the same battery housing, the cells can be connected in any manner well known in the art, for example in series or parallel, within the self-contained battery housing, without resorting to additional cell enclosures and electronic cell voltage control devices.

The following non-limiting example further exemplifies the battery housings embodied in the present invention.

### COMPARATIVE EXAMPLE

The following comparative example demonstrates the superior barrier properties of a battery housing made from a laminate comprising two separate layers of metal foil. In this example, the solvent barrier characteristics of a pouch made from a laminate comprising two separate layers of aluminum foil were compared to a pouch made from a laminate comprising a single thicker layer of aluminum foil. The double foil laminate was made with two layers of 9-μm thick aluminum foil attached together by a thin layer of solvent-cast adhesive. The single foil laminate was comprised of aluminum that had a thickness of 25 μm. Each laminate used a 50 μm thick layer of polypropylene as the sealant layer. Both laminates were fashioned into pouches and filled with a solvent and heat sealed. The transmission rate from both pouches was determined by measuring the rate of weight loss with time at various temperatures. The results showed that the double foil pouch had a lower rate of solvent loss as compared to the single foil pouch, even though the single foil was thicker than the combined thickness of the two thinner foils.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above.

While preferred embodiments have been illustrated and described, it should be understood that changes and modifications may be made therein in accordance with ordinary skill in the art departing from the invention in its broader aspects as defined in the following claims.

What is claimed is:

1. A laminate for use as a battery housing, comprising:
(a) a sealant layer that is capable of acting as a barrier to an electrolyte, the sealant layer having an internal surface that is substantially inert to the electrolyte and an external surface;
(b) a barrier layer comprising a first layer of metal foil and a second layer of metal foil adjacent to the first layer, the barrier layer having a first surface disposed adjacent to the external surface of the sealant layer and an external surface.

2. The laminate of claim 1, further comprising a layer of adhesive material between at least one pair of layers selected from the first and the second layers of metal foil and the sealant layer and the first layer of metal foil.

3. The laminate of claim 1 wherein the first and second layers of metal foil comprise aluminum foil.

4. The laminate of claim 1 wherein the first layer and the second layer of metal foil each have a thickness of between 6 micrometers and 120 micrometers.

5. The laminate of claim 1 wherein the sealant layer is a polymer.

6. The laminate of claim 5 wherein the sealant layer is selected from the group consisting of polyesters, polyamides, polyvinylchlorides, fluoroplastics, and polyolefins.

7. The laminate of claim 5 wherein the polymer is selected from the group consisting of low density polyethylene, high density polyethylene, medium density polyethylene, linear low density polyethylene (LLDPE), two-ply high density polyethylene/linear low density polyethylene, ethylene interpolymers, polyethylene terephthalate, polypropylene, polychloro-trifluoroethylene, polyphenylene sulfide, ethylene vinyl acetate, ethylene vinyl alcohol, nitrile resin films, nylon, rubber, and combinations thereof.

8. The laminate of claim 1, further comprising a protective layer having a surface disposed adjacent to the external surface of the moisture barrier layer.

9. The laminate of claim 8 wherein the protective layer is a polymer.

10. The laminate of claim 9 wherein the protective layer is selected from the group consisting of polyesters, polyamides, polyvinylchlorides, fluoroplastics, polyacrylonitrile, and polyolefins.

11. The laminate of claim 9 wherein the polymer is selected from the group consisting of low density polyethylene, high density polyethylene, medium density polyethylene, linear low density polyethylene (LLDPE), two-ply high density polyethylene/linear low density polyethylene, ethylene interpolymers, polyethylene terephthalate, polypropylene, polyacrylonitrile, polychloro-trifluoroethylene, polyphenylene sulfide, ethylene vinyl acetate, ethylene vinyl alcohol, nitrile resin films, nylon, rubber, and combinations thereof.

12. The laminate of claim 1 wherein sealant layer contains an absorbent material.

13. The laminate of claim 12 wherein the absorbent material is selected from the group consisting of molecular sieves, magnesium phosphate, calcium sulfate, silica gel, clays, activated charcoal, activated alumina, water absorbent resins, titanium oxide, zirconium oxide, calcium oxide, and combinations thereof.

14. The laminate of claim 2 wherein the adhesive contains an absorbent material.

15. The laminate of claim 14 wherein the absorbent material is selected from the group consisting of molecular sieves, magnesium phosphate, calcium sulfate, silica gel, clays, activated charcoal, activated alumina, water absorbent resins, titanium oxide, zirconium oxide, calcium oxide, and combinations thereof.

16. The laminate of claim 8 wherein the protective layer contains an absorbent material.

17. The laminate of claim 16 wherein the absorbent material is selected from the group consisting of molecular sieves, magnesium phosphate, calcium sulfate, silica gel, clays, activated charcoal, activated alumina, water absorbent resins, titanium oxide, zirconium oxide, calcium oxide, and combinations thereof.

18. The laminate of claim 1, further comprising an absorbent material coated onto the internal surface of the sealant layer.

19. The laminate of claim 18 wherein the absorbent material is selected from the group consisting of molecular sieves, magnesium phosphate, calcium sulfate, silica gel, clays, activated charcoal, activated alumina, water absorbent resins, titanium oxide, zirconium oxide, calcium oxide, and combinations thereof.

20. A laminate for use as a battery housing, comprising:
(a) a sealant layer that is capable of acting as a barrier to an electrolyte, the sealant layer having an internal surface that is substantially inert to the electrolyte and an external surface;
(b) an absorbent material pattern printed on the internal surface of the sealant layer.

21. The laminate of claim 20 wherein the absorbent material is a moisture absorbent selected from the group consisting of molecular sieves, magnesium phosphate, calcium sulfate, silica gel, activated charcoal, water absorbent resins, and combinations thereof.

22. The laminate of claim 20 wherein the absorbent material is a hydrofluoric acid absorbent selected from the group consisting of activated alumina, activated charcoal, molecular sieves, clays, titanium oxide, zirconium oxide, calcium oxide, and combinations thereof.

23. The laminate of claim 20 wherein the sealant layer contains an absorbent material.

24. The laminate of claim 20 further comprising a barrier layer characterized by an internal surface that is disposed adjacent to the external surface of the sealant layer and an external surface.

25. The laminate of claim 24 wherein the barrier layer contains an absorbent material.

26. The laminate of claim 24, further comprising an adhesive material between the sealant layer and the barrier layer.

27. The laminate of claim 26 wherein the adhesive material contains an absorbent material.

28. The laminate of claim 24, further comprising a protective layer characterized by an internal surface that is disposed adjacent to the external surface of the barrier layer and an external surface.

29. The laminate of claim 28 wherein the protective layer contains an adhesive material.

30. The laminate of claim 28, further comprising an adhesive material between the protective layer and the barrier layer.

31. The laminate of claim 30 wherein the adhesive material contains an absorbent material.

32. A housing for a battery, comprising:
(a) a laminate comprising a sealant layer that is capable of acting as a barrier to an electrolyte, the sealant layer having an internal surface that is substantially inert to the electrolyte and an external surface, wherein the laminate is fashioned into a pouch having at least one seam that is double sealed by a first and a second sealing region such that a channel is defined between the first and the second sealing regions; and
(b) an absorbent material located within the channel defined by the first and second sealing regions of the double seal.

33. The laminate of claim 32 wherein the absorbent material is a moisture absorbent selected from the group consisting of molecular sieves, magnesium phosphate, calcium sulfate, silica gel, activated charcoal, water absorbent resins, and combinations thereof.

34. The laminate of claim 32 wherein the absorbent material is a hydrofluoric acid absorbent selected from the group consisting of activated alumina, activated charcoal, molecular sieves, clays, titanium oxide, zirconium oxide, calcium oxide, and combinations thereof.
